(19) United States
(12) Patent Application Publication
(10) Pub. No.: US 2026/0080032 A1
(43) Pub. Date: Mar. 19, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Shizu Sakakibara, Kawasaki Kanagawa (JP); Daisuke Yamaguchi, Ota Tokyo (JP)

(73) Assignee: KABUSHIKI KAISHA TOSHIBA, Tokyo (JP)

(21) Appl. No.: 19/271,447

(22) Filed: Jul. 16, 2025

(30) Foreign Application Priority Data
Sep. 18, 2024 (JP) 2024-160639

(51) Int. Cl. G06F 17/12; G06F 17/17

(52) U.S. Cl. CPC G06F 17/12; G06F 17/17

(57) ABSTRACT

An information processing apparatus according to an embodiment includes a hardware processor connected to a memory. The hardware processor detects an approximation pair constituted by two solutions from among multiple solutions of a combinatorial optimization problem. The two solutions approximate to each other within a predetermined approximation range. The hardware processor detects, as a representative path, a path that traces the approximation pair in the multiple solutions from an initial solution among the multiple solutions to a target solution different from the initial solution among the multiple solutions.

### CROSS-REFERENCE TO RELATED APPLICATIONS

This application is based upon and claims the benefit of priority from Japanese Patent Application No. 2024-160639, filed on Sep. 18, 2024; the entire contents of which are incorporated herein by reference.

### FIELD

Embodiments described herein relate generally to an information processing apparatus, an information processing method, and a computer program product.

### BACKGROUND

Techniques of automatically generating plans such as schedules with less violation of preset constraint conditions have been widely used.

Such a technique is used for solving various combinatorial optimization problems such as a shift scheduling problem in which work time periods (shifts) are assigned to workers on a daily basis, other scheduling problems, and an assignment problem.

In a combinatorial optimization problem in which a large number of constraint conditions are set, such as a shift scheduling problem, there can be no solution that satisfies all the constraint conditions. Such a combinatorial optimization problem with no solution that satisfies all the constraint conditions requires a solution that minimizes a constraint violation amount representing the amount of violated constraint conditions.

In some cases, a change in setting values has occurred after a plan has been generated by solving a combinatorial optimization problem, and the combinatorial optimization problem needs to be solved again with the changed setting values. In such a case, it is better for a new plan to have a small change amount from the original plan. Meanwhile, it is better for the new plan to have the minimum constraint violation amount.

However, it is quite difficult to execute optimization processing that reduces the change amount from the original plan and minimizes the constraint violation amount. Therefore, in such a case, it is preferable to present plural solutions to a planner together with information representing the change amount from the original solution and the constraint violation amount for each of the solutions, in order for the planner to select one of the presented solutions.

In addition, for a plan that is executed by a person, when a new plan has been generated by changing the original plan, a situation arises in which how the plan has been changed needs to be explained to the person who executes the plan in order for the change to be accepted. In such a situation, it is preferable for the planner to be able to acquire, in addition to the final new plan, information for recognizing the process of the change from the original plan to the new plan.

Moreover, a combinatorial optimization problem is applied not only to the generation of a plan, but also to various techniques. Even in techniques other than the generation of a plan, a situation can arise in which a task or the like needs to be changed after the task or the like using a solution to a combinatorial optimization problem has been executed, and the combinatorial optimization problem needs to be solved again. Even in such a case, a situation can arise in which how the task or the like has been changed needs to be explained, and it is preferable to be able to acquire, in addition to the content of the task based on the final new solution, information for recognizing the process of the change from the original task to the new task.

### BRIEF DESCRIPTION OF THE DRAWINGS

FIG. 1 is a diagram illustrating an example of a configuration of an information processing apparatus according to a first embodiment;

FIG. 2 is a diagram illustrating a configuration of a path detection unit;

FIG. 3 is a flowchart illustrating a processing procedure of the information processing apparatus according to the first embodiment;

FIG. 4 is a diagram illustrating a first example of a plan based on an initial solution;

FIG. 5 is a diagram illustrating an example of a plan based on a target solution;

FIG. 6 is a diagram illustrating shift patterns for one day;

FIG. 7 is a diagram for explaining value change processing;

FIG. 8 is a diagram for explaining processing for swapping values within the same solution;

FIG. 9 is a diagram illustrating a combination of patterns with a change amount of 1 or less;

FIG. 10 is a diagram for explaining determination as to an approximation pair;

FIG. 11 is a diagram illustrating an example of a graph;

FIG. 12 is a diagram illustrating a first example of transition information;

FIG. 13 is a diagram illustrating a relationship between a change amount and an objective function value (constraint violation amount);

FIG. 14 is a diagram illustrating an example of a configuration of an information processing apparatus according to a second embodiment;

FIG. 15 is a diagram illustrating a second example of a plan based on an initial solution;

FIG. 16 is a diagram illustrating a second example of transition information;

FIG. 17 is a diagram illustrating an example of a configuration of an information processing apparatus according to a third embodiment;

FIG. 18 is a diagram illustrating an example of a bipartite graph;

FIG. 19 is a diagram illustrating an example of costs set in the bipartite graph;

FIG. 20 is a diagram illustrating an example of an initial solution in a bipartite graph matching problem;

FIG. 21 is a diagram illustrating an example of costs set in a bipartite graph after a change;

FIG. 22 is a diagram illustrating an example of a target solution in a bipartite graph matching problem;

FIG. 23 is a diagram illustrating an example of approximation definition information;

FIG. 24 is a diagram illustrating a candidate solution and transition information in a bipartite graph matching problem; and

FIG. 25 is a diagram illustrating an example of a hardware configuration of the information processing apparatus.

### DETAILED DESCRIPTION

An information processing apparatus according to an embodiment includes a hardware processor connected to a memory. The hardware processor is configured to detect an approximation pair constituted by two solutions from among multiple solutions of a combinatorial optimization problem. The two solutions approximate to each other within a predetermined approximation range. The hardware processor is configured to detect, as a representative path, a path that traces the approximation pair in the multiple solutions from an initial solution among the multiple solutions to a target solution different from the initial solution among the multiple solutions.

### First Embodiment

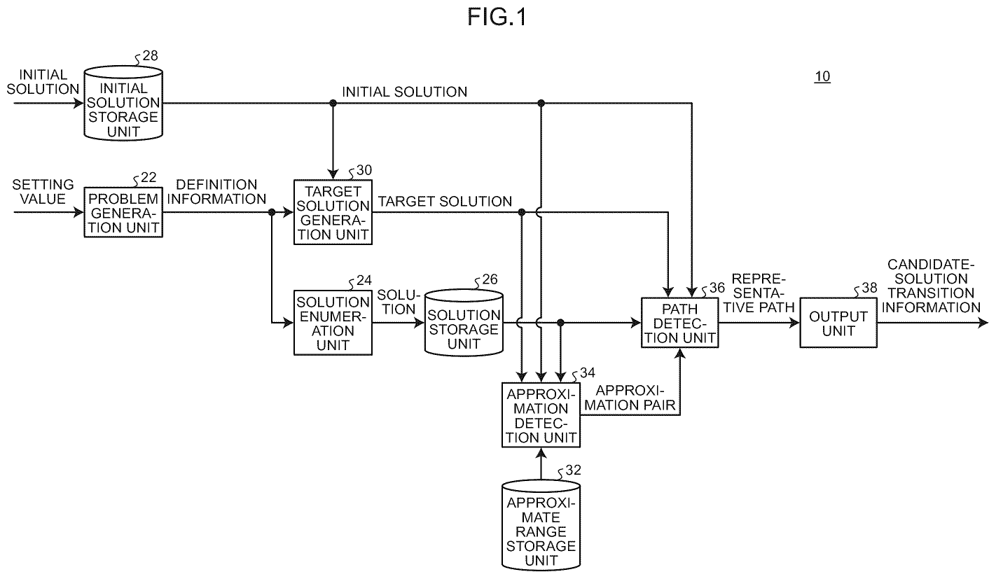

FIG. 1 is a diagram illustrating an example of a configuration of an information processing apparatus 10 according to a first embodiment.

The information processing apparatus 10 receives one or more setting values from a user, and generates definition information defining a combinatorial optimization problem based on the received one or more setting values. Based on the definition information defining the combinatorial optimization problem, the information processing apparatus 10 detects a representative path from an initial solution to a target solution. Then, the information processing apparatus 10 outputs one or more candidate solutions that trace the representative path and outputs transition information representing the representative path.

Examples of the combinatorial optimization problem are a shift scheduling problem in which work time periods (shifts) are assigned to each of a plurality of workers on a daily basis, other scheduling problems, an assignment problem, and the like.

The information processing apparatus 10 includes a problem generation unit 22, a solution enumeration unit 24, a solution storage unit 26, an initial solution storage unit 28, a target solution generation unit 30, an approximation definition storage unit 32, an approximation detection unit 34, a path detection unit 36, and an output unit 38. The information processing apparatus 10 functions as a processing unit that executes information processing.

The problem generation unit 22 is preset with function information representing a function expression that is a source of an objective function in the combinatorial optimization problem. For example, the problem generation unit 22 is preset with function information representing a functional form of a constraint expression representing each of one or more constraint conditions in the combinatorial optimization problem. The objective function includes a plurality of decision variables. Each of the decision variables is a discrete variable. Note that some of the decision variables may be continuous variables.

The problem generation unit 22 further acquires one or more setting values. The one or more setting values is input by the user. Some of the one or more setting values may be preset values.

The problem generation unit 22 generates the definition information defining the combinatorial optimization problem based on the function information and the one or more setting values. For example, the problem generation unit 22 generates, for each of the constraint conditions, a constraint expression representing whether the constraint condition is satisfied by substituting a corresponding setting value among the one or more setting values into a coefficient in each of one or more constraint expressions indicated by the function information. Then, based on the constraint expression corresponding to each of the constraint conditions, the problem generation unit 22 generates an objective function representing a constraint violation amount that violates the one or more constraint conditions, as the definition information defining the combinatorial optimization problem.

For example, the constraint violation amount is the number of constraint conditions violated among the one or more constraint conditions. In addition, when a penalty coefficient is set for each of the one or more constraint conditions, the constraint violation amount may be a value obtained by summing all penalty coefficients of violated constraint conditions.

The solution enumeration unit 24 enumerates multiple solutions of the combinatorial optimization problem, based on the definition information defining the combinatorial optimization problem. For example, the solution enumeration unit 24 may enumerate all of possible solutions for the combinatorial optimization problem, or may enumerate some of all the possible solutions for the combinatorial optimization problem. Note that the solution enumeration unit 24 may enumerate the solutions including a solution that does not satisfy the constraint conditions.

In addition, the solution enumeration unit 24 may enumerate the solutions under a condition that some of the decision variables are the designated fixed values. In addition, the solution enumeration unit 24 may enumerate the solutions obtained by excluding a solution that satisfies a preset exclusion condition from all the possible solutions for the combinatorial optimization problem. The exclusion condition may be, for example, a condition that makes the constraint violation amount so large that no solution that satisfies the condition can be selected as a candidate solution. The exclusion condition may be, for example, an optional condition set by the user. In addition, the solutions enumerated by the solution enumeration unit 24 may include two or more identical solutions.

The solution storage unit 26 stores the solutions enumerated by the solution enumeration unit 24.

The initial solution storage unit 28 is given an initial solution from, for example, the user or an external device, and stores the given initial solution.

The initial solution is one of all the solutions of the combinatorial optimization problem. For example, when a change in the setting values has occurred after a plan has been generated based on a solution obtained by solving the combinatorial optimization problem, the initial solution is a solution that is a source of the plan before the setting values are changed. Note that the initial solution may be a solution that is optionally selected from among all the solutions of the combinatorial optimization problem.

The target solution generation unit 30 acquires the definition information defining the combinatorial optimization problem generated by the problem generation unit 22. The target solution generation unit 30 generates a target solution based on the acquired definition information defining the combinatorial optimization problem. Note that the target solution generation unit 30 may be configured to be given a target solution from the user or an external device and output the given target solution, for example.

The target solution is one of all the solutions of the combinatorial optimization problem, and is a solution different from the initial solution. For example, the target solution is a solution obtained by executing optimization processing for optimizing the objective function in the combinatorial optimization problem. For example, when the objective function in the combinatorial optimization problem represents a constraint violation amount that violates the one or more constraint conditions, the target solution is a solution obtained by executing the optimization processing for minimizing the objective function. In this case, the target solution may be a solution that satisfies all the one or more constraint conditions, or may be a solution that does not satisfy some of the one or more constraint conditions.

In the present embodiment, the target solution generation unit 30 executes the optimization processing on the objective function to generate the target solution. The optimization processing is processing based on, for example, a rule based solution construction method (Greedy algorithm, Neighborhood search), a genetic algorithm (GA), Simulated annealing (SA), an enumeration based search method, Branch and bound, and the like. In addition, the target solution generation unit 30 may generate the target solution using a general-purpose solver that solves the optimization problem, for example. The target solution generation unit 30 may generate the target solution using a quantum annealing device or an Ising machine, for example.

The approximation definition storage unit 32 stores approximation definition information describing a determination criterion for determining whether two solutions constitute an approximation pair. The two solutions approximate to each other within a predetermined approximation range.

The determination criterion is a criterion for determining whether a first solution, which is one of the set of two solutions, and a second solution, which is the other one of the set of two solutions, approximate to each other. For example, the determination criterion describes that the first solution and the second solution approximate to each other when the change amount for changing the first solution to the second solution is equal to or less than a predetermined upper limit value, or is within a range between a predetermined lower limit value or more and the upper limit value or less.

The change amount may be, for example, the number of times of value change processing when the value is changed until the first solution matches the second solution or the number of times of value swapping processing within the same solution. In addition, the change amount may be the Hamming distance between the first solution and the second solution. In addition, the change amount may be the distance between the first solution and the second solution calculated by combining one or more of neighborhood definitions, such as 2-opt, 3-pot, 2-swap, 3-swap, or 2-exchange used in Neighborhood search.

The approximation detection unit 34 acquires all sets of two solutions included in the solutions stored in the solution storage unit 26. The approximation detection unit 34 detects whether each of the acquired sets of two solutions is an approximation pair based on the approximation definition information stored in the approximation definition storage unit 32. For example, the approximation detection unit 34 detects a set of two solutions as the approximation pair when the change amount in a case where the first solution, which is one of the set of two solutions, is changed to the second solution, which is different from the first solution of the set of two solutions, is equal to or less than the predetermined upper limit value, or is within a range between the predetermined lower limit value or more and the upper limit value or less.

Note that, when the initial solution is not included in the solutions stored in the solution storage unit 26, the approximation detection unit 34 acquires all sets of two solutions including the initial solution in the solutions stored in the solution storage unit 26. In addition, when the target solution is not included in the solutions stored in the solution storage unit 26, the approximation detection unit 34 acquires all sets of two solutions including the target solution in the solutions stored in the solution storage unit 26.

The path detection unit 36 acquires the initial solution from the initial solution storage unit 28. The path detection unit 36 acquires the target solution generated by the target solution generation unit 30. The path detection unit 36 acquires the solutions stored in the solution storage unit 26. The path detection unit 36 acquires the approximation pair detected by the approximation detection unit 34.

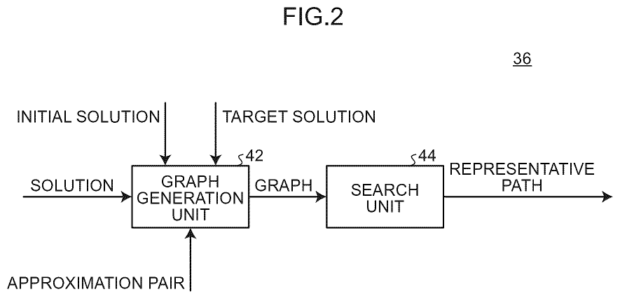

Then, the path detection unit 36 detects, as a representative path, a path that traces the approximation pair from the initial solution to the target solution among all paths tracing the solutions. In addition, when the representative path is not present in all paths tracing the solutions, the path detection unit 36 outputs information representing that the representative path is not present. Note that further details of the path detection unit 36 will be described later with reference to FIG. 2.

The output unit 38 acquires the representative path from the path detection unit 36. In addition, the output unit 38 acquires one or more solutions included in the representative path as one or more candidate solutions. Then, the output unit 38 outputs the acquired one or more candidate solutions and transition information representing the order of the one or more candidate solutions in the representative path. For example, the output unit 38 displays the one or more candidate solutions and the transition information on a display device or transmits the one or more candidate solutions and the transition information to another computer or the like via a network.

In addition, when the path detection unit 36 has not detected the representative path, the output unit 38 outputs the information representing that the representative path is not present in the solutions.

The output unit 38 may output a change amount from the initial solution for at least one solution among the one or more candidate solutions included in the representative path. For example, the output unit 38 may output a change amount from the initial solution for each of the one or more candidate solutions included in the representative path.

In addition, the output unit 38 may output an evaluation value corresponding to an objective function value obtained by substituting at least one solution among the one or more candidate solutions included in the representative path into the objective function in the combinatorial optimization problem. For example, the output unit 38 may output an evaluation value for each of the one or more candidate solutions included in the representative path.

FIG. 2 is a diagram illustrating a configuration of the path detection unit 36. The path detection unit 36 includes a graph generation unit 42 and a search unit 44.

The graph generation unit 42 acquires the solutions stored in the solution storage unit 26, the approximation pair, the initial solution, and the target solution. The graph generation unit 42 generates a graph based on the solutions, the approximation pair, the initial solution, and the target solution.

The graph includes a plurality of nodes. These nodes corresponds to the solutions including the initial solution and the target solution on a one-to-one basis.

The graph includes a plurality of edges. Each of the edges connects two nodes corresponding to the two solutions constituting the approximation pair among the nodes. A weight value may be set for each of the edges. The weight value may be a predetermined constant such as 1. In addition, the weight value may be the change amount between the two solutions corresponding to the two nodes connected by the edge. An edge that connects two nodes corresponding to two solutions with different evaluation values may be an oriented edge in a direction from a node corresponding to a solution with a smaller evaluation value to a node corresponding to a solution with a larger evaluation value.

In addition, the graph may include an edge connecting two nodes corresponding to two solutions that do not constitute the approximation pair. However, in this case, the weight value of the edge connecting the two nodes corresponding to the two solutions that do not constitute the approximation pair is set to a value that is sufficiently larger than the other edges, for example, a value that is treated as infinite.

The search unit 44 acquires the graph generated by the graph generation unit 42. Then, the search unit 44 executes search processing for searching for a path tracing the edge from the node corresponding to the initial solution to the node corresponding to the target solution in the graph to detect the representative path.

For example, in the search processing, the search unit 44 searches for a path that minimizes the number of nodes to be passed, and sets the path obtained by the search as the representative path. In addition, for example, in the search processing, the search unit 44 may search for a path with a minimum cumulative weight value obtained by accumulating weight values set for edges to be passed from the node corresponding to the initial solution to the node corresponding to the target solution, and set the path obtained by the search as the representative path.

For example, the search unit 44 may search for a path that minimizes the number of nodes to be passed or a path that minimizes the cumulative weight value using Dijkstra's algorithm. In addition, the search unit 44 may search for a path that minimizes the number of nodes to be passed or a path that minimizes the cumulative weight value using a method other than Dijkstra's algorithm.

Note that, as a result of the search processing, instead of a minimum path in which the number of nodes to be passed is strictly minimum or the cumulative weight value is strictly minimum, the search unit 44 may detect, as the representative path, an approximate path in which the number of nodes to be passed is greater than the minimum path or the cumulative weight value is greater than the minimum path.

In addition, when the path tracing the edge from the node corresponding to the initial solution to the node corresponding to the target solution in the graph is not present, or when the number of nodes to be passed or the cumulative weight value is greater than a preset threshold, the search unit 44 outputs the information representing that the representative path is not present.

The path detection unit 36 having the above-noted configuration can detect, as the representative path, a path tracing the approximation pair from the initial solution to the target solution among all paths tracing the solutions.

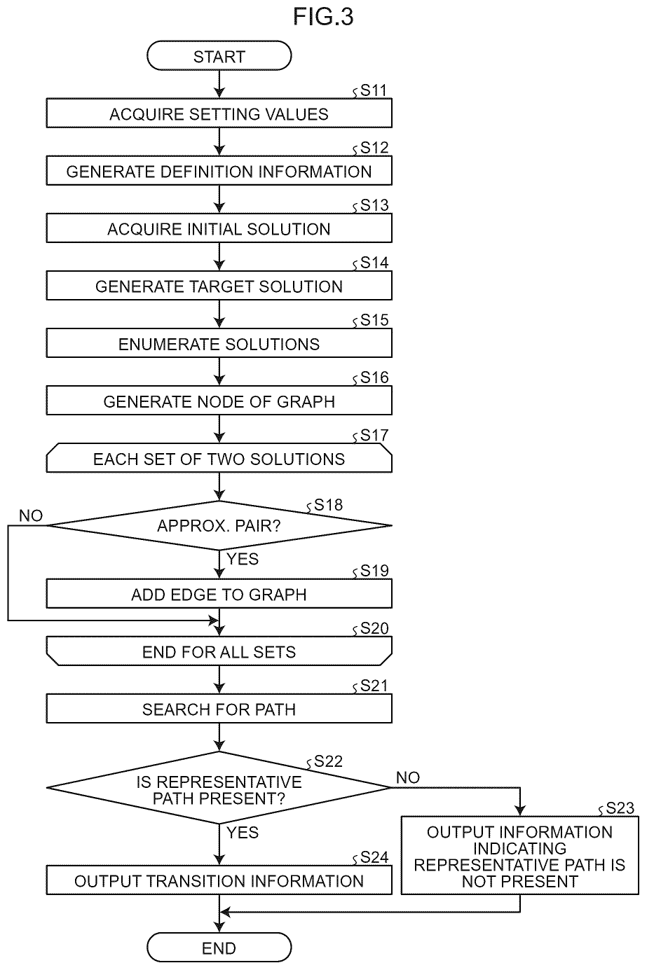

FIG. 3 is a flowchart illustrating a processing procedure of the information processing apparatus 10 according to the first embodiment.

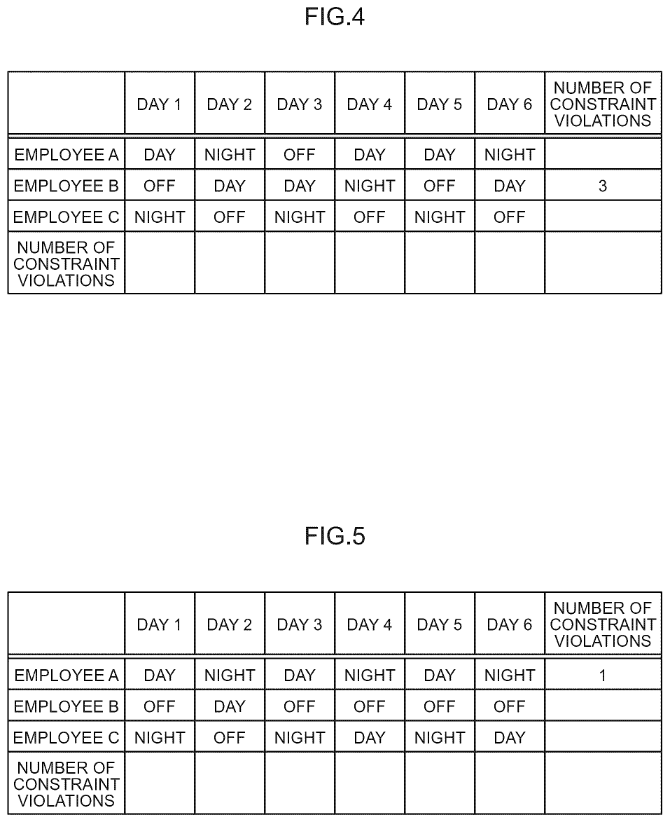

The information processing apparatus 10 according to the first embodiment executes processing with the procedure illustrated in FIG. 3. Note that, to explain the flowchart in FIG. 3, FIGS. 4 to 13 will be referred to.

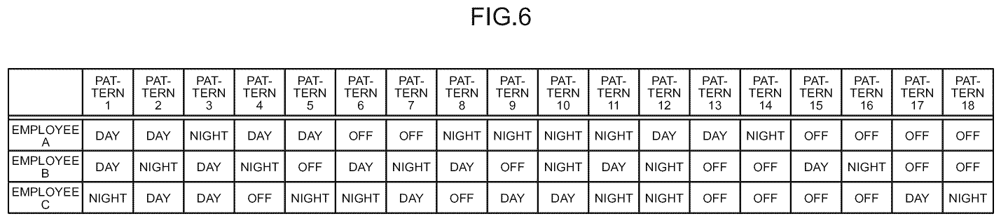

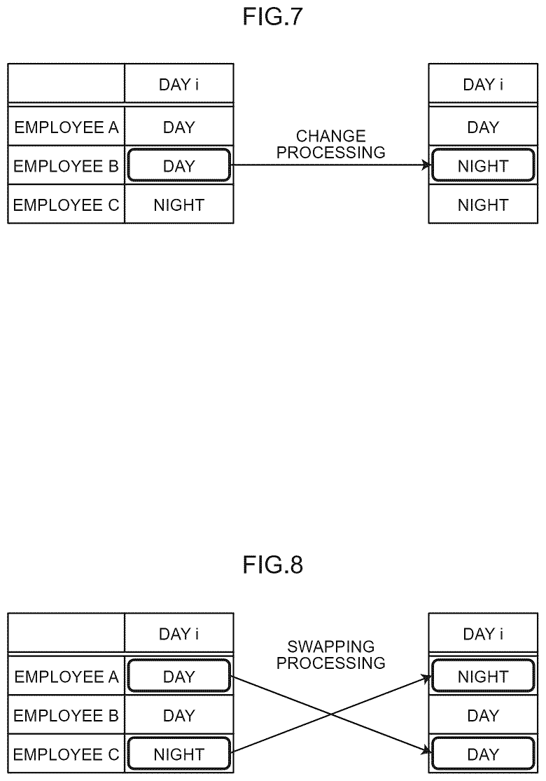

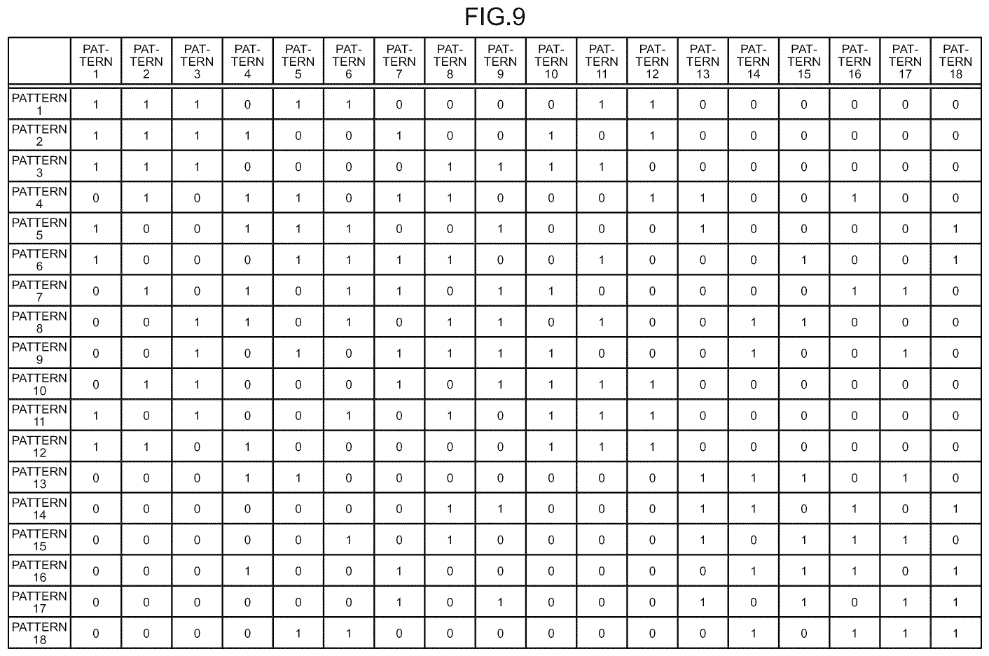

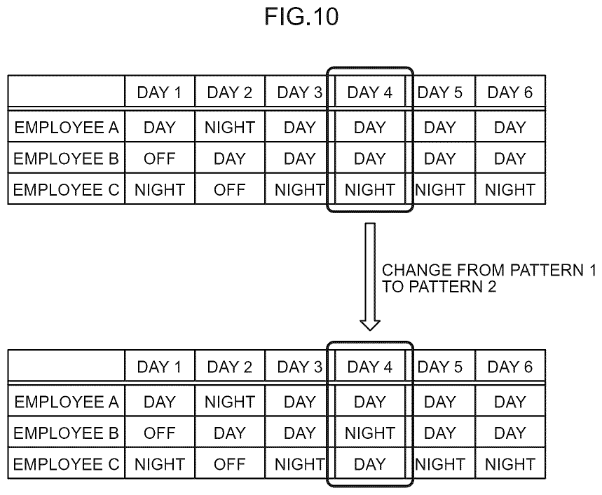

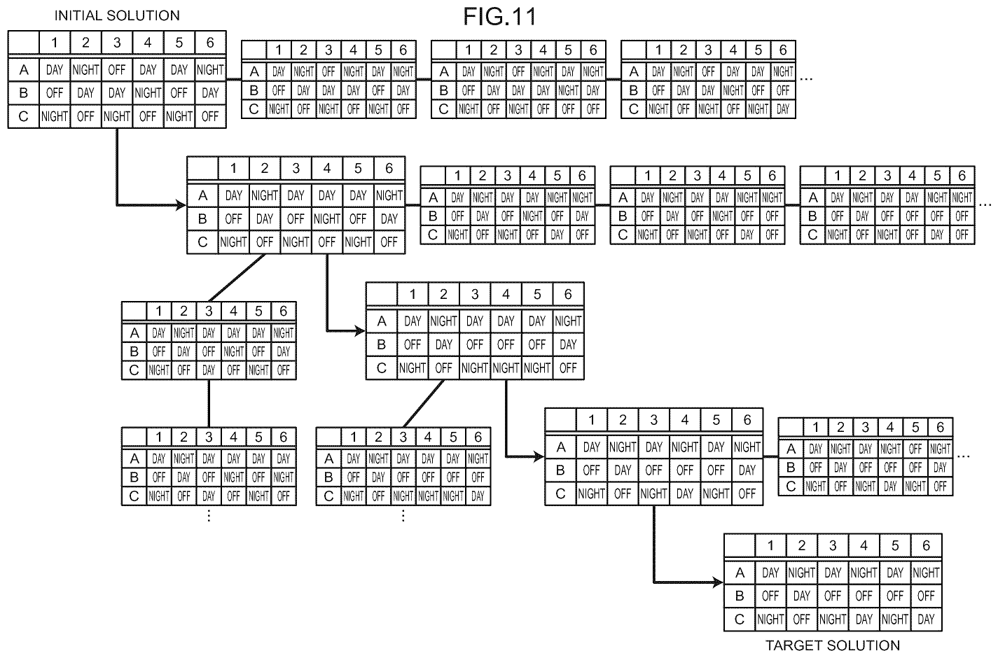

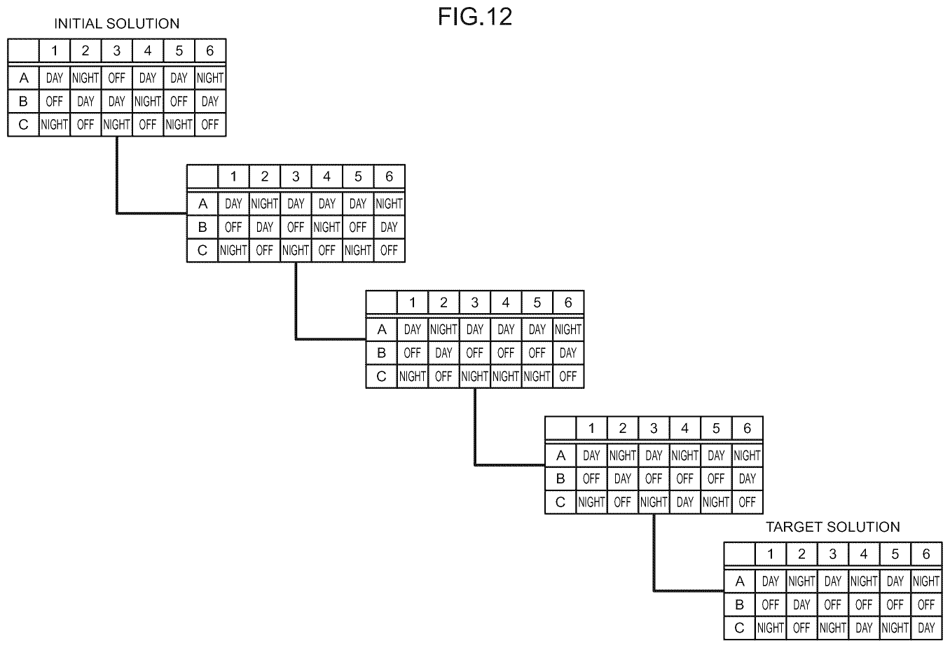

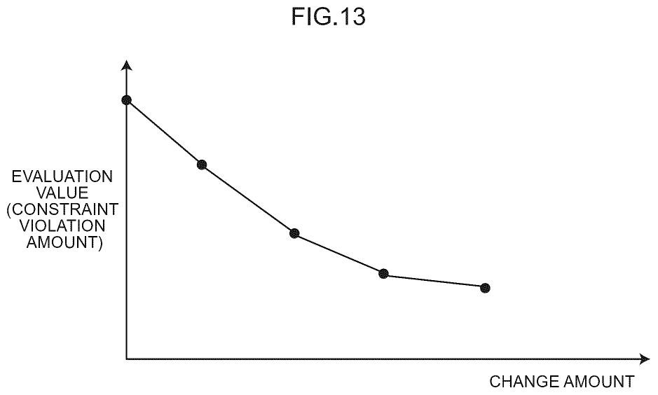

FIG. 4 is a diagram illustrating a first example of a plan based on the initial solution. FIG. 5 is a diagram illustrating an example of a plan based on the target solution. FIG. 6 is a diagram illustrating shift patterns for one day satisfying a first constraint condition, a second constraint condition, a third constraint condition, and a seventh constraint condition. FIG. 7 is a diagram for explaining value change processing. FIG. 8 is a diagram for explaining value swapping processing within the same solution. FIG. 9 is a diagram illustrating a combination of patterns with a change amount of 1 or less. FIG. 10 is a diagram for explaining determination as to an approximation pair. FIG. 11 is a diagram illustrating an example of a graph. FIG. 12 is a diagram illustrating a first example of the transition information. FIG. 13 is a diagram illustrating a relationship between the change amount and the objective function value (constraint violation amount).

First, in S11, the information processing apparatus 10 acquires setting values input by the user.

In the present example, the combinatorial optimization problem is a scheduling problem in which work time periods (shifts) are assigned to each of employees on a daily basis. In the present example, there are three types of shifts: “day” for the day time period, “night” for the night time period, and “off” for a day off.

In the present example, the information processing apparatus 10 acquires setting values indicating that the employees to be scheduled is three persons: an employee (A), an employee (B), and an employee (C). In the present example, the information processing apparatus 10 acquires setting values indicating that a planning period to be scheduled is 6 days from Day 1 to Day 6.

In addition, the information processing apparatus 10 acquires, as the constraint conditions, setting values representing the first to sixth constraint conditions described below.

The first constraint condition is a constraint condition representing that a plan is generated so as to assign any shift of day, night, or off to each of the employees on a daily basis.

The second constraint condition is a constraint condition representing that a plan is generated so as to assigning one shift to each of the employees on a daily basis.

The third constraint condition is a constraint condition representing that a plan is generated so as not to assign the same shift to two or more employees on a daily basis.

The fourth constraint condition is a constraint condition representing that a plan is generated so as to assign a day shift to one or more employees and a night shift to one or more employees on a daily basis.

The fifth constraint condition is a constraint condition representing that a plan is generated so as not to assign a night shift to the same employee for two or more consecutive days.

The sixth constraint condition is a constraint representing that a plan is generated so as to assign one or more off shifts during the planning period to each of the employees.

Moreover, the present example is executed when the original plan is to be changed because the shifts from Day 3 to Day 6 of the employee (B) are off due to his/her injury after the plan has been executed until Day 2 of the planning period.

Therefore, the information processing apparatus 10 further acquires, as the constraint conditions, setting values representing the seventh constraint condition and eighth constraint condition described below.

The seventh constraint condition is a constraint condition representing that a plan is generated so as to assign the same shifts as the initial solution to each of the employees on Day 1 and Day 2.

The eighth constraint condition is a constraint condition representing that a plan is generated so as to assign off shifts to the employee (B) on Day 3 to Day 6.

In the present example, the information processing apparatus 10 acquires the setting values as described above.

Subsequently, in S12, the information processing apparatus 10 generates definition information defining a combinatorial optimization problem. In the present example, an objective function of the combinatorial optimization problem is a function that calculates the number of shifts that violate each of the first to eighth constraint conditions as a constraint violation amount. The information processing apparatus 10 generates such a problem that minimizes the objective function as the definition information for defining the combinatorial optimization problem. Note that the objective function of the combinatorial optimization problem may be a function in which the importance is set for each of the constraint conditions, and the higher the importance, the larger the constraint violation amount when the constraint is not satisfied.

In S13, the information processing apparatus 10 acquires the initial solution.

For example, the initial solution is a solution that is a source of the plan before the change.

In the present example, the information processing apparatus 10 acquires the initial solution illustrated in FIG. 4. The initial solution illustrated in FIG. 4 has been executed until Day 2 of the planning period.

Note that, in the initial solution of the example illustrated in FIG. 4, three shifts of the employee (B) on Day 3, Day 4, and Day 6 violate the eighth constraint condition. Therefore, the objective function value in the initial solution of the example illustrated in FIG. 4, namely, the constraint violation amount is 3.

Subsequently, in S14, the information processing apparatus 10 generates a target solution based on the definition information defining the combinatorial optimization problem. For example, the information processing apparatus 10 executes optimization processing for minimizing the objective function to generate the target solution. Note that the information processing apparatus 10 may be given a target solution from, for example, the user or an external device.

In the present example, the information processing apparatus 10 generates the target solution illustrated in FIG. 5. The target solution of the example illustrated in FIG. 5 violates the sixth constraint condition because no off shift is assigned to the employee (A) during the planning period. Therefore, the objective function value in the target solution of the example illustrated in FIG. 5, namely, the constraint violation amount is 1.

Subsequently, in S15, the information processing apparatus 10 enumerates solutions of the combinatorial optimization problem based on the definition information defining the combinatorial optimization problem.

For example, the information processing apparatus 10 may set one or more constraint conditions with higher importance among the constraint conditions and enumerate solutions that satisfy these one or more constraint conditions with higher importance. In the present example, the information processing apparatus 10 enumerates solutions that satisfy the first constraint condition, the second constraint condition, the third constraint condition, and the seventh constraint condition. In this case, as illustrated in FIG. 6, the information processing apparatus 10 generates 18 patterns as shifts for one day that satisfy the first constraint condition, the second constraint condition, the third constraint condition, and the seventh constraint condition. Then, the information processing apparatus 10 sets the shifts on Day 1 and Day 2 to be the same as the initial solution, and generates 18⁴ solutions in which the shifts for 4 days from Day 3 to Day 6 are combined in 18 patterns.

In addition, for example, the information processing apparatus 10 may exclude a solution that satisfies an exclusion condition that extremely increases the constraint violation amount among the solutions enumerated in this manner. For example, in the thirteenth to eighteenth patterns in FIG. 6, off shifts are assigned to two or more employees in one day, which increases the constraint violation amount, and the patterns cannot be selected as candidate solutions. Therefore, the information processing apparatus 10 may exclude a solution in which off shifts are assigned to two or more employees in one day from the enumerated solutions.

Subsequently, in S16, the information processing apparatus 10 generates nodes of a graph. More specifically, the information processing apparatus 10 generates nodes corresponding to the enumerated solutions on a one-to-one basis. At this point, the graph does not include edges. In the present example, the information processing apparatus 10 generates a graph including 18⁴ nodes.

Note that, when the initial solution is not included in the enumerated solutions, the information processing apparatus 10 adds the initial solution to the solutions. In addition, when the target solution is not included in the enumerated solutions, the information processing apparatus 10 adds the target solution to the solutions.

Subsequently, the information processing apparatus 10 executes the processing of S18 and S19 for each set of two solutions included in the enumerated solutions (loop processing between S17 and S20). Specifically, the information processing apparatus 10 extracts sets of two solutions from among the enumerated solutions and executes the processing of S18 and S19 on the extracted sets of two solutions. In this processing, the information processing apparatus 10 extracts all sets of two solutions included in the enumerated solutions.

In S18, the information processing apparatus 10 determines whether each of target sets of two solutions is an approximation pair. For example, the information processing apparatus 10 determines the approximation pair based on approximation definition information describing a determination criterion for determining the approximation pair.

For example, when the change amount for changing the first solution to the second solution is equal to or less than a predetermined upper limit value, or is within a range between a predetermined lower limit value or more and the upper limit value or less, the information processing apparatus 10 determines that a set of the first solution and the second solution is the approximation pair. Note that the first solution is one of a target set of two solutions. In addition, the second solution is a solution different from the first solution in the target set of two solutions.

The information processing apparatus 10 calculates, as the change amount, the number of times of value change processing, the number of times of value swapping processing within the same solution, or the number of times of execution of both processing in changing the first solution to the second solution. For example, as illustrated in FIG. 7, the value change processing is processing for changing a shift of an optional employee on an optional day (Day i) (i is an integer of 1 or more) to another shift. The value swapping processing within the same solution is, for example, processing for swapping a shift of the first employee and a shift of the second employee on an optional day (Day i) as illustrated in FIG. 8.

Then, when the change amount is equal to or less than a predetermined upper limit value, or is within a range between a predetermined lower limit value or more and the upper limit value or less, the information processing apparatus 10 determines that the set of the first solution and the second solution is the approximation pair. For example, in the examples of FIGS. 7 and 8, when the change amount is 1, the information processing apparatus 10 determines that the set of the first solution and the second solution is the approximation pair.

In addition, when patterns representing shifts for one day as illustrated in FIG. 6 are set in advance, the information processing apparatus 10 may store a value indicating whether the change amount is equal to or less than an upper limit value or a value indicating whether the change amount is equal to or more than the lower limit value and is equal to or less than the upper limit value for each combination of the patterns. For example, the information processing apparatus 10 may store a table in which a combination of patterns with the change amount of 1 or less is represented by 1 and a combination of patterns with the change amount greater than 1 is represented by 0 as illustrated in FIG. 9. In this case, when the first solution and the second time in the set of two solutions are values indicating whether the change amount is the upper limit value or less or values indicating whether the change amount is the lower limit value or more and the upper limit value or less on all days in the planning deadline, the information processing apparatus 10 determines that the set is the approximation pair.

For example, the first solution (upper solution) and the second solution (lower solution) in FIG. 10 have different shifts of the employee (B) on Day 3, but all other shifts are the same. In addition, Day 3 of the first solution is the first pattern in FIG. 6. In addition, Day 3 of the second solution is the second pattern in FIG. 6. In this case, the information processing apparatus 10 refers to the value of the cell in the table in FIG. 9 where the first pattern and the second pattern intersect, and determines that the change amount between the first solution (upper solution) and the second solution (lower solution) illustrated in FIG. 10 is 1 or less, since the value of the referred cell is 1. Then, in this case, the information processing apparatus 10 determines that the set of the first solution and the second solution illustrated in FIG. 10 is the approximation pair.

When the target set of two solutions is not the approximation pair (No in S18), the information processing apparatus 10 proceeds to the processing for the next set of two solutions without executing the processing in S19. When the target set of two solutions is the approximation pair (Yes in S18), the information processing apparatus 10 proceeds to S19.

In S19, the information processing apparatus 10 adds, to the graph, an edge connecting a node corresponding to the first solution and a node corresponding to the second solution in the target set of two solutions (approximation pair). In this case, the information processing apparatus 10 may set a predetermined value, such as 1, as the weight value of the edge. In addition, the information processing apparatus 10 may set the change amount between the first solution and the second solution to the weight value of the edge.

When the processing of S18 and S19 has been executed on all sets of two solutions included in the enumerated solutions, the information processing apparatus 10 proceeds to S21.

In S21, the information processing apparatus 10 executes search processing for searching for a path that traces edges from the node corresponding to the initial solution to the node corresponding to the target solution in the graph to detect a representative path.

For example, the information processing apparatus 10 searches for a path that minimizes the number of nodes to be passed, and sets the path obtained by the search as the representative path. In addition, for example, the information processing apparatus 10 may search for a path with a minimum cumulative weight value obtained by accumulating weight values set for edges to be passed from the node corresponding to the initial solution to the node corresponding to the target solution, and set the path obtained by the search as the representative path. In the present example, the information processing apparatus 10 searches a graph as illustrated in FIG. 11 to detect a representative path from the initial solution to the target solution with the minimum number of nodes.

Subsequently, in S22, the information processing apparatus 10 determines whether the representative path has been detected from the graph. When the representative path has not been detected (No in S22), the information processing apparatus 10 proceeds to S23, and when the representative path has been detected (Yes in S22), the information processing apparatus proceeds to S24.

In S23, the information processing apparatus 10 outputs information representing that the representative path is not present. For example, the information processing apparatus 10 displays, on a display device, the information representing that the representative path is not present or transmits the information to another computer or the like via a network.

In S24, the information processing apparatus 10 outputs one or more candidate solutions included in the representative path and transition information representing the order of the one or more candidate solutions in the representative path. For example, the information processing apparatus 10 displays the one or more candidate solutions and the transition information on a display device or transmits the one or more candidate solutions and the transition information to another computer or the like via a network. In the present example, the information processing apparatus 10 displays, on the display device, the one or more candidate solutions and the transition information as illustrated in FIG. 12.

The information processing apparatus 10 may output the change amount from the initial solution and an evaluation value corresponding to an objective function value obtained by substituting each of the one or more candidate solutions included in the representative path into the objective function.

In the present example, the information processing apparatus 10 outputs the constraint violation amount as the evaluation value corresponding to the objective function value. In addition, as illustrated in FIG. 13, the information processing apparatus 10 may output an image representing a line graph in which points corresponding to the initial solution, the target solution, and each of the one or more candidate solutions are plotted in a two-dimensional region in which the first axis (for example, the horizontal axis) indicates the change amount from the initial solution and the second axis (for example, the vertical axis) indicates the constraint violation amount.

When the processing of S23 or S24 is completed, the information processing apparatus 10 terminates this procedure.

As described above, the information processing apparatus 10 according to the first embodiment outputs a representative path tracing an approximate solution(s) among a large number of paths from an initial solution to a target solution among multiple solutions of a combinatorial optimization problem. As a result, with the information processing apparatus 10 according to the first embodiment, it is possible to allow the user to confirm one or more candidate solutions in the representative path from the initial solution to the target solution. In addition, it is possible for the information processing apparatus 10 according to the first embodiment to present information representing a change amount from the initial solution and a constraint violation amount to the user for each of the one or more candidate solutions, thereby allowing the user to select an appropriate candidate solution from among the one or more presented candidate solutions, and presenting to the user how the initial solution has been changed to generate the target solution.

### Second Embodiment

Next, an information processing apparatus 10 according to a second embodiment will be described. Since the information processing apparatus 10 according to the second embodiment has substantially the same function and configuration as those in the first embodiment, substantially the same constitutional elements are denoted by the same reference signs, and detailed descriptions thereof will be omitted. The same applies to a third embodiment.

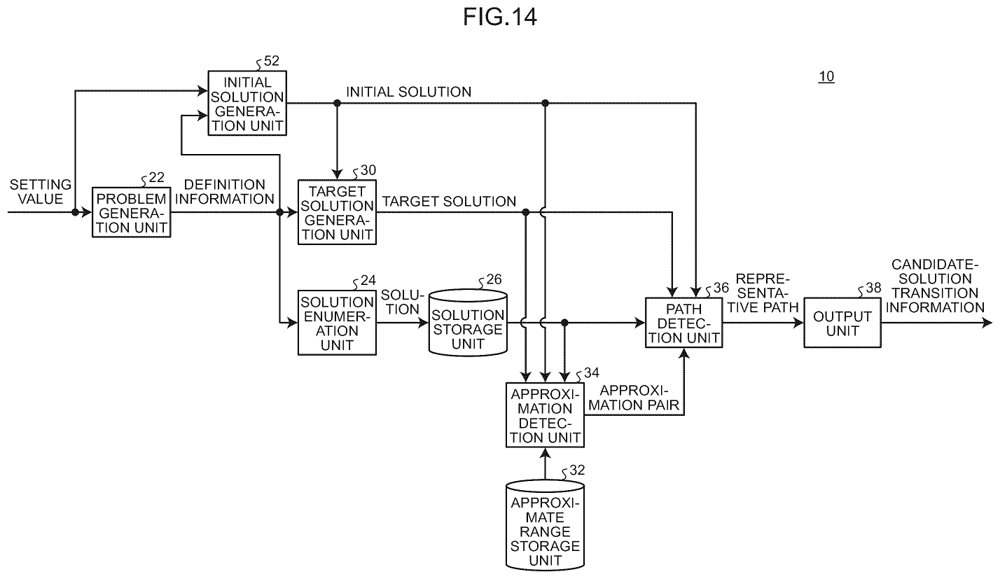

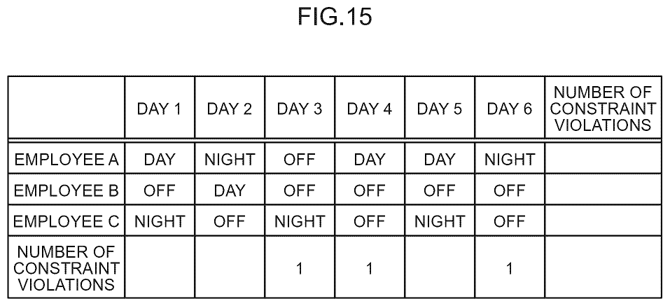

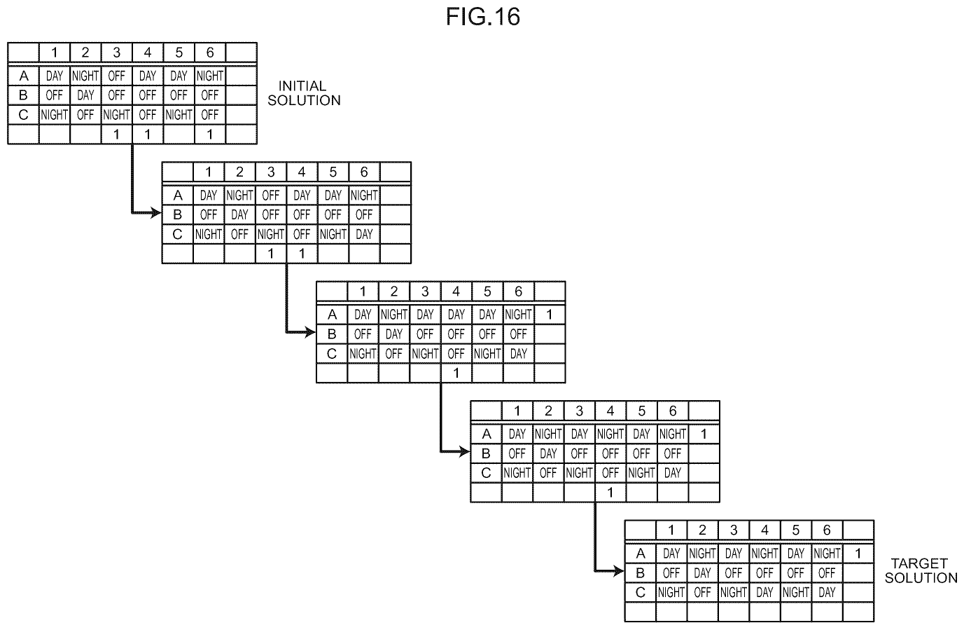

FIG. 14 is a diagram illustrating an example of a configuration of the information processing apparatus 10 according to the second embodiment. Note that, the configuration of FIG. 14 is described with reference to FIGS. 15 to 16. FIG. 15 is a diagram illustrating a second example of a plan based on an initial solution. FIG. 16 is a diagram illustrating a second example of transition information.

The information processing apparatus 10 according to the second embodiment includes an initial solution generation unit 52 instead of the initial solution storage unit 28.

The initial solution generation unit 52 acquires definition information defining a combinatorial optimization problem from a problem generation unit 22. The initial solution generation unit 52 generates an initial solution based on the definition information defining the combinatorial optimization problem. Note that the initial solution generation unit 52 may acquire some of one or more setting values acquired by the problem generation unit 22.

The initial solution generation unit 52 acquires, as the initial solution, a solution in which some decision variables among solutions are fixed to predetermined values. The initial solution generation unit 52 according to the present example generates the initial solution when the original plan is to be changed because the shifts from Day 3 to Day 6 of an employee (B) are off due to his/her injury after the plan has been executed until Day 2 of the planning period. Therefore, in the present example, the initial solution generation unit 52 generates, as the initial solution, an optional solution in which shifts of each of employees on Day 1 and Day 2 are fixed to the shifts in the original plan before changing the plan, and the shifts of the employee (B) on Day 3 to Day 6 are fixed to off shifts.

Similarly to the initial solution generation unit 52, a solution enumeration unit 24 according to the second embodiment enumerates values in which some decision variables are fixed to predetermined values. For example, the solution enumeration unit 24 enumerates solutions in which shifts of each of the employees on Day 1 and Day 2are fixed to the shifts in the original plan before changing the plan, and the shifts of the employee (B) on Day 3 to Day 6 are fixed to off shifts.

For example, when the solutions is enumerated based on the patterns illustrated in FIG. 6, the solution enumeration unit 24 according to the second embodiment combines not all the eighteen patterns but six patterns of the fifth, ninth, thirteenth, fourteenth, seventeenth, and eighteenth patterns in which the shifts of the employee (B) are fixed to off shifts on Day 3 to Day 6, and thereby generates 6⁴ solutions. As a result, the solution enumeration unit 24 can reduce the number of paths searched for and shorten the processing time of the search processing of a path detection unit 36.

In the present example, the information processing apparatus 10 generates the initial solution illustrated in FIG. 15. In addition, in the present example, the information processing apparatus 10 displays, on a display device, one or more candidate solutions and transition information as illustrated in FIG. 16.

As described above, when the original plan is to be changed, the information processing apparatus 10 according to the second embodiment can generate an initial solution that further satisfies constraints. As a result, it is possible for the information processing apparatus 10 according to the second embodiment to make the initial solution a feasible solution, acquire a candidate solution with a better objective function value, and shorten a representative path. Therefore, with the information processing apparatus 10 according to the second embodiment, it is possible to generate a candidate solution that is more easily accepted by the user.

### Third Embodiment

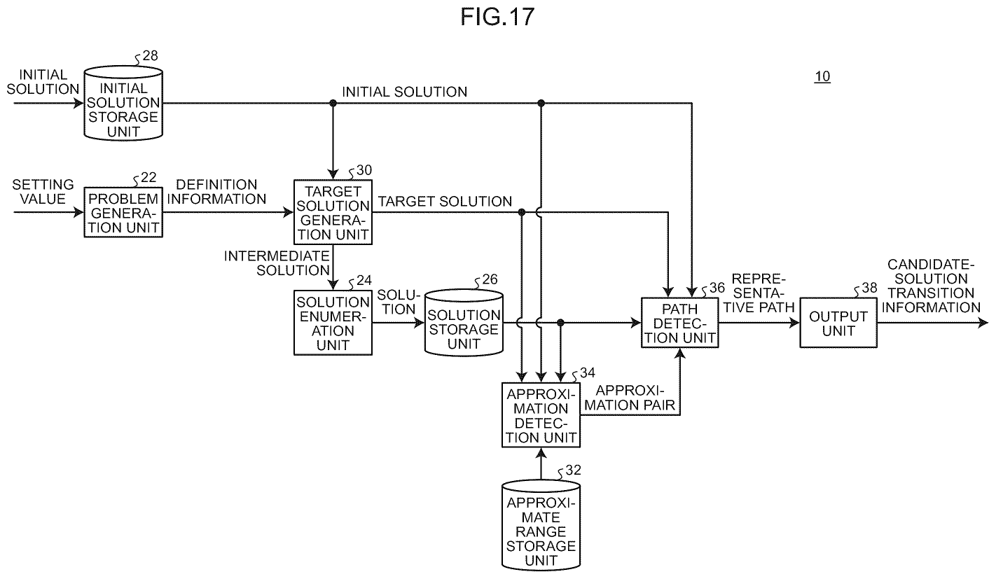

FIG. 17 is a diagram illustrating an example of a configuration of an information processing apparatus 10 according to a third embodiment.

A solution enumeration unit 24 according to the third embodiment acquires a plurality of intermediate solutions generated by a target solution generation unit 30 during the generation of a target solution. The solution enumeration unit 24 according to the third embodiment enumerates a plurality of solutions based on the acquired plurality of intermediate solutions.

The target solution generation unit 30 executes optimization processing for searching for an optimal solution that minimizes the value of an objective function. As an algorithm and a device for executing the optimization processing, for example, a rule based solution construction method, a genetic algorithm, Simulated annealing, an enumeration based search method, Branch and bound, solving processing by a general-purpose solver, solving processing using a quantum annealing device, and solving processing using an Ising machine are known. Both the algorithm and the device generate a large number of intermediate solutions during the search as well as the finally obtained solution.

In Branch and bound, a certain first decision variable is selected, and a range of possible values for the selected first decision variable is divided into, for example, two to generate branches. Subsequently, in Branch and bound, when the selected first decision variable is a discrete variable that takes 0 or 1, a branch of 0 or 1 is generated for the selected first decision variable. Subsequently, in Branch and bound, for the 0 branch for the first decision variable, a range of possible values for a second decision variable is divided into, for example, two to generate branches. Thereafter, in Branch and bound, such branching is repeated for all decision variables to determine the best provisional solution detected so far. Then, in Branch and bound, the provisional solution is updated repeatedly to finally detect an optimal solution.

When the target solution generation unit 30 generates the target solution using such Branch and bound, the solution enumeration unit 24 acquires an intermediate solution every time a provisional solution is selected. As a result, the solution enumeration unit 24 can enumerate a plurality of solutions based on a plurality of acquired intermediate solutions. Note that, in Branch and bound, a provisional solution and an estimation value (bound or upper bound) of the best objective function value calculated at the tip of each branch are used for estimating whether a better solution than the provisional solution will not be found even if the search is further executed. Then, in Branch and bound, when it is estimated that no solution is found, the processing is terminated. For this reason, when the target solution generation unit 30 generates the target solution using such Branch and bound, the solution enumeration unit 24 cannot acquire all the solutions of a combinatorial optimization problem. However, in general, Branch and bound generates a large number of intermediate solutions, and it is possible to enumerate sufficiently number of effective solutions.

As described above, the information processing apparatus 10 according to the third embodiment enumerates a plurality of solutions using a plurality of intermediate solutions generated during the generation of a target solution, and it is possible to reduce the processing load for enumerating the solutions. Note that the solution enumeration unit 24 according to the third embodiment can also be applied to the second embodiment.

### Application Example to Bipartite Graph Matching Problem

The information processing apparatus 10 according to the first to third embodiments can be applied not only to a scheduling problem but also to other types of combinatorial optimization problems. Hereinafter, an example in which the information processing apparatus 10 according to the first to third embodiments is applied to a bipartite graph matching problem will be described.

FIG. 18 is a diagram illustrating an example of a bipartite graph. The bipartite graph includes two subsets. Each of the two subsets includes a plurality of nodes. In the example of FIG. 18, a first subset, which is one of the two subsets, includes five nodes a, b, c, d, and e. In the example of FIG. 18, a second subset, which is the other of the two subsets, includes five nodes A, B, C, D, and E.

In addition, the bipartite graph includes a plurality of edges. Each of the edges connects a node in the first subset of the two subsets and a node in the second subset of the two subsets. The bipartite graph does not include an edge that connects two nodes in the same subset.

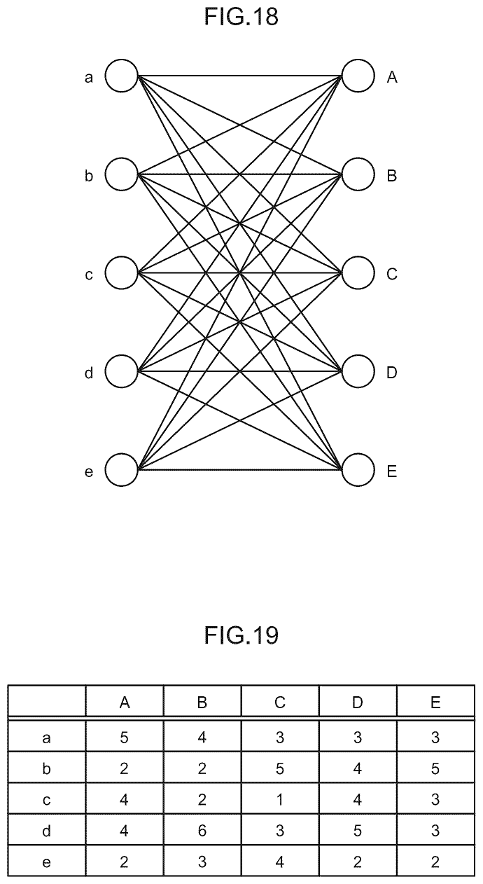

FIG. 19 is a diagram illustrating an example of costs set for the edges included in the bipartite graph. As illustrated in FIG. 19, a cost is set for each of the edges included in the bipartite graph. The bipartite graph matching problem is a problem in which each of the nodes included in the first subset is matched with any one of the nodes included in the second subset so as to maximize the total cost.

Such a bipartite graph matching problem illustrated in FIGS. 18 and 19 can be used, for example, when any one of five jobs (A, B, C, D, E) is assigned to each of five workers (a, b, c, d, e) for maximum work efficiency.

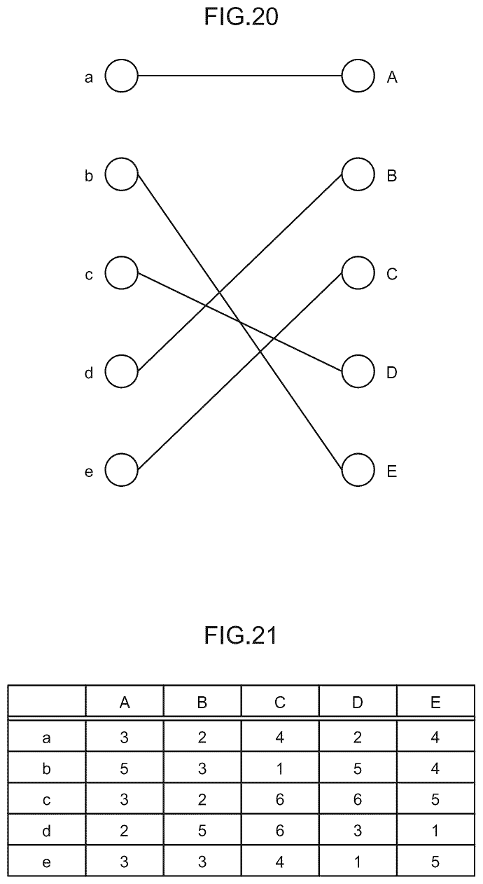

FIG. 20 is a diagram illustrating an example of an initial solution in the bipartite graph matching problem. When the costs illustrated in FIG. 19 are set, the information processing apparatus 10 acquires, for example, the initial solution as illustrated in FIG. 20 externally. Note that, instead of acquiring the initial solution externally, the information processing apparatus 10 may generate the initial solution based on definition information defining the bipartite graph matching problem. The initial solution illustrated in FIG. 20 represents a matching relationship in which the total cost is maximized when the costs illustrated in FIG. 19 are set.

FIG. 21 is a diagram illustrating an example of costs set for each of the edges included in the bipartite graph after a change. For example, it is assumed that the costs of the bipartite graph have been changed from the values illustrated in FIG. 19 to the values illustrated in FIG. 21 for some reason. For example, when the work efficiency of each of the five workers is changed after the start of the job, the cost set for each of the edges included in the bipartite graph is changed.

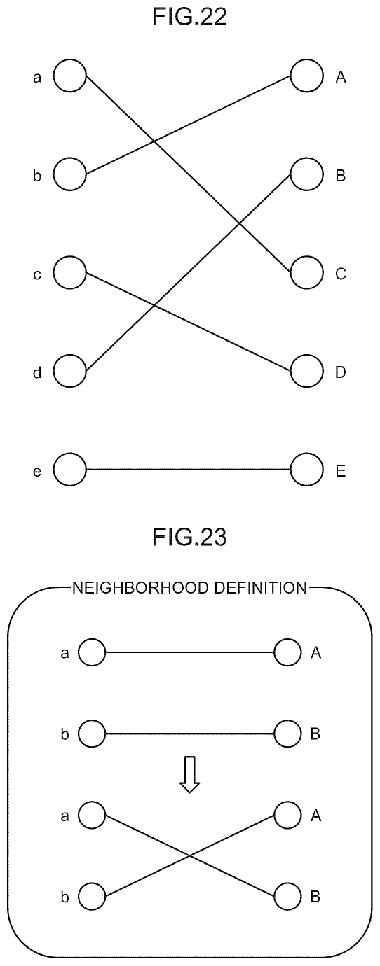

FIG. 22 is a diagram illustrating an example of a target solution in the bipartite graph matching problem. When the costs of the bipartite graph have been changed from the values illustrated in FIG. 19 to the values illustrated in FIG. 21, the information processing apparatus 10 acquires, for example, a target solution as illustrated in FIG. 22. The target solution illustrated in FIG. 22 represents a matching relationship in which the total cost is maximized when the costs illustrated in FIG. 21 are set.

The information processing apparatus 10 enumerates a plurality of solutions to the bipartite graph matching problem. For example, the information processing apparatus 10 enumerates the solutions by a method of calculating and enumerating all permutations of the five jobs and sequentially assigning the permutations to the five workers.

FIG. 23 is a diagram illustrating an example of approximation definition information. The information processing apparatus 10 stores approximation definition information describing a determination criterion for determining whether a set of two solutions is an approximation pair that is a set of two approximate solutions within a predetermined approximation range.

The approximation definition information may describe that a set of a first solution and a second solution is the approximation pair when the first solution can be changed to the second solution by executing correspondence swapping processing of swapping the correspondence between the two edges as illustrated in FIG. 23 a predetermined number of times or less. In the present example, the approximation definition information describes that a set of the first solution and the second solution is the approximation pair when one-time execution of the correspondence swapping processing illustrated in FIG. 23 leads to the same.

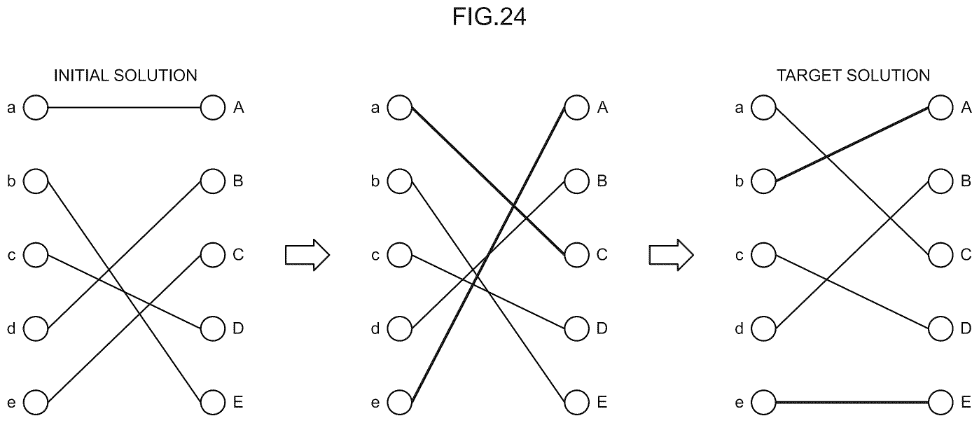

FIG. 24 is a diagram illustrating an example of a candidate solution and transition information in the bipartite graph matching problem. The information processing apparatus 10 can generate a candidate solution and transition information as illustrated in FIG. 24 based on the bipartite graph matching problem of the present example. As a result, the information processing apparatus 10 can first swap the job (A) of the worker (a) for the job (C) of the worker (e) in the initial solution, and subsequently swap the job (E) of the worker (b) for the job (A) of the worker (e), thereby presenting to the user that the target solution has been generated.

As described above, the information processing apparatus 10 according to the first to third embodiments can be applied not only to a scheduling problem but also to other optimization problems such as a bipartite graph matching problem.

### Hardware configuration of Information processing apparatus 10

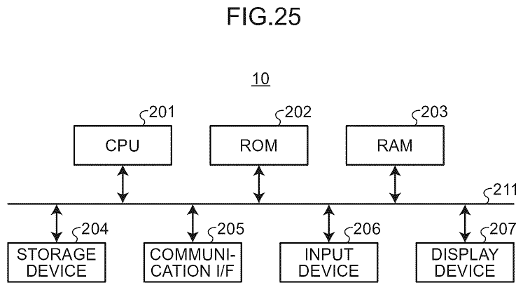

FIG. 25 is a diagram illustrating an example of a hardware configuration of the information processing apparatus 10.

The information processing apparatus 10 is achieved by a computer having a hardware configuration as illustrated in FIG. 25, for example. The information processing apparatus 10 includes a CPU 201, a read only memory (ROM) 202, a random access memory (RAM) 203, a storage device 204, a communication I/F 205, an input device 206, and a display device 207. These units are connected by a bus 211.

The CPU 201 is a processor that executes arithmetic processing, control processing, and the like in accordance with a computer program. The CPU 201 uses a predetermined area of the RAM 203 as a work area, and executes various types of processing in cooperation with computer programs stored in the ROM 202, the storage device 204, and the like.

The ROM 202 is a memory that stores computer programs and various types of information in a non-rewritable manner. The RAM 203 is a memory such as a synchronous dynamic random access memory (SDRAM). The RAM 203 functions as a work area of the CPU 201.

The storage device 204 is a device that writes and reads data in and from a semiconductor storage medium such as a flash memory, a magnetically or optically recordable storage medium, or the like. The storage device 204 writes and reads data to and from the storage medium under the control of the CPU 201. The communication I/F 205 communicates with an external device via a network under the control of the CPU 201.

The input device 206 is an input device such as a mouse and a keyboard. The input device 206 receives information input by operation from an administrator as an instruction signal, and outputs the instruction signal to the CPU 201.

The display device 207 is a display device such as a liquid crystal display (LCD). The display device 207 displays various types of information based on a display signal from the CPU 201.

The computer program executed by the information processing apparatus 10 includes a problem generation module, a solution enumeration module, a target solution generation module, an approximation detection module, a path detection module, and an output module. The computer program executed by the information processing apparatus 10 may further include an initial solution generation module.

The computer program is developed and executed on the RAM 203 by the CPU 201 (an example of a hardware processor), thereby causing the information processing apparatus 10 to function as the problem generation unit 22, the solution enumeration unit 24, the target solution generation unit 30, the approximation detection unit 34, the path detection unit 36, and the output unit 38. The computer program may cause the information processing apparatus 10 to function as the initial solution generation unit 52. Note that each of the problem generation unit 22, the solution enumeration unit 24, the target solution generation unit 30, the approximation detection unit 34, the path detection unit 36, the output unit 38, and the initial solution generation unit 52 may be partly or fully achieved in hardware circuitry. In addition, the computer program causes the RAM 203 or the storage device 204 to function as the solution storage unit 26, the initial solution storage unit 28, and the approximation definition storage unit 32.

In addition, the computer program executed by the information processing apparatus 10 is a file in a format that can be installed or executed on the information processing apparatus 10, and is provided by being recorded on a recording medium readable by the information processing apparatus 10, such as a CD-ROM, a flexible disc, a CD-R, or a digital versatile disk (DVD).

The computer program may be stored on the information processing apparatus 10 connected to a network such as the Internet, and provided by being downloaded via the network. The computer program may be configured to be provided or distributed via a network such as the Internet. The computer program executed by the information processing apparatus 10 may be provided by being incorporated in the ROM 202 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Notes

The above embodiment can be summarized in the following technical schemes.

### (Technical Scheme 1)

An information processing apparatus comprising
a hardware processor connected to a memory and configured to:
   detect an approximation pair constituted by two solutions from among multiple solutions of a combinatorial optimization problem, the two solutions approximating to each other within a predetermined approximation range; and
   detect, as a representative path, a path tracing the approximation pair in the multiple solutions from an initial solution among the multiple solutions to a target solution different from the initial solution among the multiple solutions.

### (Technical Scheme 2)

The information processing apparatus according to the technical scheme 1, wherein the hardware processor is further configured to output one or more candidate solutions included in the representative path and output transition information representing an order of the one or more candidate solutions in the representative path.

### (Technical Scheme 3)

The information processing apparatus according to the technical scheme 2, wherein the hardware processor is further configured to, when the representative path is not present in the multiple solutions, output information representing that the representative path is not present.

### (Technical Scheme 4)

The information processing apparatus according to the technical scheme 2 or 3, wherein the hardware processor is further configured to output change amount information representing a change amount from the initial solution for at least one candidate solution among the one or more candidate solutions included in the representative path.

### (Technical Scheme 5)

The information processing apparatus according to any one of the technical schemes 2 to 4, wherein the hardware processor is further configured to output an evaluation value corresponding to an objective function value, the objective function value being obtained by substituting at least one candidate solution among the one or more candidate solutions included in the representative path into an objective function in the combinatorial optimization problem.

### (Technical Scheme 6)

The information processing apparatus according to any one of the technical schemes 2 to 5, wherein the hardware processor is further configured to
acquire one or more setting values, and
generate, based on the acquired the one or more setting values, definition information defining the combinatorial optimization problem.

### (Technical Scheme 7)

The information processing apparatus according to any one of the technical schemes 1 to 6, wherein the hardware processor is further configured to, in the detection of the representative path,
generate a graph including multiple nodes and an edge, the multiple nodes corresponding to the multiple solutions on a one-to-one basis, the edge connecting two nodes corresponding to two solutions included in the approximation pair among the multiple nodes, and
detect the representative path by executing search processing of searching for a path tracing an edge from a node corresponding to the initial solution to a node corresponding to the target solution in the graph.

### (Technical Scheme 8)

The information processing apparatus according to the technical scheme 7, wherein the hardware processor is further configured to, in the search processing, search for a path minimizing the number of nodes to be passed.

### (Technical Scheme 9)

The information processing apparatus according to the technical scheme 7, wherein
the hardware processor is further configured to, in the search processing, search for a path minimizing a cumulative weight value obtained by accumulating a weight value set for each edge to be passed from the node corresponding to the initial solution to the node corresponding to the target solution, and
the weight value is a change amount between the two solutions corresponding to the two nodes connected to the edge for which the weight value is set.

### (Technical Scheme 10)

The information processing apparatus according to any one of the technical schemes 1 to 9, wherein the hardware processor is further configured to, in the detection of the representative path, detect the set of two solutions as the approximation pair in accordance with a change amount for changing a first solution to a second solution within the set of two solutions, the set of two solutions as the approximation pair being detected when the change amount is equal to or less than a predetermined upper limit value or when the change amount is within a range between a predetermined lower limit value or more and the upper limit value or less.

### (Technical Scheme 11)

The information processing apparatus according to any one of the technical schemes 1 to 10, wherein the hardware processor is further configured to generate the initial solution based on definition information defining the combinatorial optimization problem.

### (Technical Scheme 12)

The information processing apparatus according to any one of the technical schemes 1 to 11, wherein the hardware processor is further configured to generate the target solution based on definition information defining the combinatorial optimization problem.

### (Technical Scheme 13)

The information processing apparatus according to the technical scheme 12, wherein the hardware processor is further configured to
acquire intermediate solutions generated during the generation of the target solution, and
enumerate the multiple solutions based on the acquired intermediate solutions.

### (Technical Scheme 14)

The information processing apparatus according to any one of the technical schemes 1 to 12, wherein the hardware processor is further configured to enumerate the multiple solutions based on definition information defining the combinatorial optimization problem.

### (Technical Scheme 15)

An information processing method implemented by a computer, the method comprising:
detecting an approximation pair constituted by two solutions from among multiple solutions of a combinatorial optimization problem, the two solutions approximating to each other within a predetermined approximation range; and
detecting, as a representative path, a path tracing the approximation pair in the multiple solutions from an initial solution among the multiple solutions to a target solution different from the initial solution among the multiple solutions.

### (Technical Scheme 16)

A computer program product comprising a non-transitory computer readable recording medium on which a computer program executable by a computer is stored, the computer program instructing the computer to perform processing, the processing including:
detecting an approximation pair constituted by two solutions from among multiple solutions of a combinatorial optimization problem, the two solutions approximating to each other within a predetermined approximation range; and
detecting, as a representative path, a path tracing the approximation pair in the multiple solutions from an initial solution among the multiple solutions to a target solution different from the initial solution among the multiple solutions.

What is claimed is:

1. An information processing apparatus comprising
a hardware processor connected to a memory and configured to:
detect an approximation pair constituted by two solutions from among multiple solutions of a combinatorial optimization problem, the two solutions approximating to each other within a predetermined approximation range; and
detect, as a representative path, a path tracing the approximation pair in the multiple solutions from an initial solution among the multiple solutions to a target solution different from the initial solution among the multiple solutions.

2. The information processing apparatus according to claim 1, wherein the hardware processor is further configured to output one or more candidate solutions included in the representative path and output transition information representing an order of the one or more candidate solutions in the representative path.

3. The information processing apparatus according to claim 2, wherein the hardware processor is further configured to, when the representative path is not present in the multiple solutions, output information representing that the representative path is not present.

4. The information processing apparatus according to claim 2, wherein the hardware processor is further configured to output change amount information representing a change amount from the initial solution for at least one candidate solution among the one or more candidate solutions included in the representative path.

5. The information processing apparatus according to claim 2, wherein the hardware processor is further configured to output an evaluation value corresponding to an objective function value, the objective function value being obtained by substituting at least one candidate solution among the one or more candidate solutions included in the representative path into an objective function in the combinatorial optimization problem.

6. The information processing apparatus according to claim 2, wherein the hardware processor is further configured to
acquire one or more setting values, and
generate, based on the acquired the one or more setting values, definition information defining the combinatorial optimization problem.

7. The information processing apparatus according to claim 1, wherein the hardware processor is further configured to, in the detection of the representative path,
generate a graph including multiple nodes and an edge, the multiple nodes corresponding to the multiple solutions on a one-to-one basis, the edge connecting two nodes corresponding to two solutions included in the approximation pair among the multiple nodes, and
detect the representative path by executing search processing of searching for a path tracing an edge from a node corresponding to the initial solution to a node corresponding to the target solution in the graph.

8. The information processing apparatus according to claim 7, wherein the hardware processor is further configured to, in the search processing, search for a path minimizing the number of nodes to be passed.

9. The information processing apparatus according to claim 7, wherein
the hardware processor is further configured to, in the search processing, search for a path minimizing a cumulative weight value obtained by accumulating a weight value set for each edge to be passed from the node corresponding to the initial solution to the node corresponding to the target solution, and
the weight value is a change amount between the two solutions corresponding to the two nodes connected to the edge for which the weight value is set.

10. The information processing apparatus according to claim 1, wherein the hardware processor is further configured to, in the detection of the representative path, detect the set of two solutions as the approximation pair in accordance with a change amount for changing a first solution to a second solution within the set of two solutions, the set of two solutions as the approximation pair being detected when the change amount is equal to or less than a predetermined upper limit value or when the change amount is within a range between a predetermined lower limit value or more and the upper limit value or less.

11. The information processing apparatus according to claim 1, wherein the hardware processor is further configured to generate the initial solution based on definition information defining the combinatorial optimization problem.

12. The information processing apparatus according to claim 1, wherein the hardware processor is further configured to generate the target solution based on definition information defining the combinatorial optimization problem.

13. The information processing apparatus according to claim 12, wherein the hardware processor is further configured to
acquire intermediate solutions generated during the generation of the target solution, and
enumerate the multiple solutions based on the acquired intermediate solutions.

14. The information processing apparatus according to claim 1, wherein the hardware processor is further configured to enumerate the multiple solutions based on definition information defining the combinatorial optimization problem.

15. An information processing method implemented by a computer, the method comprising:
detecting an approximation pair constituted by two solutions from among multiple solutions of a combinatorial optimization problem, the two solutions approximating to each other within a predetermined approximation range; and
detecting, as a representative path, a path tracing the approximation pair in the multiple solutions from an initial solution among the multiple solutions to a target solution different from the initial solution among the multiple solutions.

16. A computer program product comprising a non-transitory computer readable recording medium on which a computer program executable by a computer is stored, the computer program instructing the computer to perform processing, the processing including:
detecting an approximation pair constituted by two solutions from among multiple solutions of a combinatorial optimization problem, the two solutions approximating to each other within a predetermined approximation range; and
detecting, as a representative path, a path tracing the approximation pair in the multiple solutions from an initial solution among the multiple solutions to a target solution different from the initial solution among the multiple solutions.
